(19) United States
(12) Patent Application Publication
(10) Pub. No.: US 2023/0229243 A1
(43) Pub. Date: Jul. 20, 2023

(54) Video Teleconferencing Program Emulating Keyboard Device and Software Application

(71) Applicant: Lance Wilkins, Prescott Valley, AZ (US)

(72) Inventor: Lance Wilkins, Prescott Valley, AZ (US)

(21) Appl. No.: 18/045,232

(22) Filed: Oct. 10, 2022

Related U.S. Application Data
(60) Provisional application No. 63/300,825, filed on Jan. 19, 2022.

(51) Int. Cl. G06F 3/02; H04W 76/10; G06F 3/16; G06F 3/023; H04N 5/232; G06F 3/01

(52) U.S. Cl. CPC G06F 3/0219; G06F 3/011; G06F 3/165; G06F 3/0231; H04N 5/23203; H04W 76/10

(57) ABSTRACT

The present invention relates to a handheld keyboard or keypad device used for interacting with one or more video teleconferencing programs running on a separate system, such as, a laptop or any other computing device. The keyboard has a plurality of functional keys for emulating controls or functions of video teleconferencing programs and can be paired with the video teleconferencing programs using a Bluetooth channel established using a wireless transceiver. The functional keys can include functional keys related to a microphone, a camera, emojis, a chat, and more, of the video teleconferencing programs. In some embodiments, the functionality of the keypad is provided by a software application installed in an electronic device. The keypad device enables users to move around and exercise while participating in their teleconference meetings and obviates the need to remain in chairs for multiple hours per day.

### CROSS-REFERENCE TO RELATED APPLICATION

The present application claims priority to, and the benefit of, U.S. Provisional Application No. 63/300,825, which was filed on Jan. 19, 2022 and is incorporated herein by reference in its entirety.

### FIELD OF THE INVENTION

The present invention relates generally to the field of video conferencing systems and applications. More specifically, the present invention relates to a handheld keyboard or a smartphone application designed to emulate functions on a video teleconferencing program. The keyboard/application includes numerous buttons that interact with the program like microphone functions, muting functions, volume control, meeting and joining keys, and more. The keyboard enables users to move around and exercise and participate in their teleconference meetings without being stuck in their chairs for multiple hours. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, working from home was widely adopted at the outset of the COVID-19 pandemic. Most companies around the globe permitted working from home for employees. In fact, in many parts of the world and in many industries, employees have been working from home even before the COVID-19 pandemic. It is also common for individuals to work from home or work remotely when their employer or workplace is located far away, such as in another city or country. Some individuals work from home due to inability of commuting to/from the office, while many work from home due to personal commitments. As a result, employees who work from home spend a considerable amount of time on teleconference meetings for collaborating with others.

While working from home provides benefits, for example: no commute, relaxed dress code, personal comfort, and more, however, there are disadvantages as well. Continuous work and teleconference meetings without any movement, while sitting in one place causes back and neck pain. Individuals miss out on physical activities and movement that they would normally get from their commute or routine. This dramatic decrease in activity leads to an increase in musculoskeletal pain, such as neck, shoulder, and low back pain. Psychological stress is often linked to back and neck pain, and as a result many individuals face higher levels of persistent stress and anxiety. Virtual fatigue or zoom fatigue is a common symptom faced by individuals who use a lot of videotelephony with working from home.

Currently, a person is required to sit in one place, such as at their work desk designed in their home, for participating in video conferencing meetings and audio meetings. Even when a person is on mute or a listener in a meeting, the person is required to sit at the computer and not move. As a result, individuals desire to work out and/or move around while able to participate in such video teleconferencing programs.

Therefore, there exists a long felt need in the art for a system that enables users to move around and exercise and participate in their teleconference meetings. There is also a long felt need in the art for a portable device that can be carried by a user while participating in teleconference meetings enabling the person to easily move around. Additionally, there is a long felt need in the art for a small keyboard like handheld device that has function keys to interact with video teleconferencing programs from a distance. Moreover, there is a long felt need in the art for a system that prevents individuals from being stuck in their chairs for long hours while participating in virtual meetings. Further, there is a long felt need in the art for a system that can come in the form of a small keyboard, software application, and more enabling individuals to participate in teleconferencing meetings while moving around. Furthermore, there is a long felt need in the art for a portable device that can help a user interact with a video conferencing application from a distance. Finally, there is a long felt need in the art for a handheld keyboard or a smartphone application that enables users to move around and exercise and participate in their teleconference meetings and prevents the users from being stuck in their chairs for multiple hours per day.

The subject matter disclosed and claimed herein, in one embodiment thereof, comprises a handheld keyboard for emulating functions of video teleconferencing programs. The keyboard is configured to enable users to move around and exercise and participate in their teleconference meetings and prevents the users from being stuck in their chairs for multiple hours. The keyboard further comprising a processor for controlling operations of the keyboard, a removable battery for providing electric power, a wireless transceiver to establish a wireless channel to pair the keyboard with a video teleconferencing program, a plurality of function keys configured to emulate functions of the video teleconferencing program, the plurality of function keys include at least microphone functions, camera functions, volume control, meeting joining keys, and emoji keys, wherein an instruction signal is transmitted from the keyboard to the video teleconferencing program when a key is actuated or pressed by a user, thereby enabling the user to interact with the video teleconferencing program from a distance. The functionality of the keyboard can also be provided by a software application.

In this manner, the video teleconferencing keyboard and the software application of the present invention accomplish all of the forgoing objectives and provide users with a handheld keyboard or a smartphone application with several buttons and options designed to emulate functions on a video teleconferencing program. The keyboard can obviate the need for teleconferencing parties to be stuck at their desks while participating in their teleconference meetings. The keyboard helps a user interact with a video conferencing application from a distance and can be easily carried by a user.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a handheld keyboard for emulating functions of video teleconferencing programs. The keyboard further comprising a processor, a removable battery, a wireless transceiver, a plurality of function keys, the wireless transceiver is configured to establish a wireless channel to pair the keyboard with a video teleconferencing program, the plurality of functions keys is configured to emulate functions of the video teleconferencing program, the plurality of function keys include at least microphone functions, camera functions, volume control, meeting joining keys, and emoji keys, wherein an instruction signal is transmitted from the keyboard to the video teleconferencing program when a key is actuated or pressed by a user, thereby enabling the user to interact with the video teleconferencing program from a distance.

In yet another embodiment, a computer implemented software application configured to emulate functions of video teleconferencing programs is disclosed. The software application configures a processor for displaying a plurality of function keys emulating functions of video teleconferencing programs; receiving a selection of at least one function key; transmitting a wireless instruction signal to a video teleconferencing program including the functionality of the selected function key; and performing an action in the video teleconferencing program corresponding to the received instruction signal.

In yet another embodiment, a small keyboard that displays different function keys with icons designed for interacting with video teleconferencing programs from a distance is disclosed. The keyboard has an accompanied wristband configured to be worn around an arm by a user, the wristband having a transparent touch sensitive pouch for securing the keyboard, the function keys are configured to emulate functions on a video teleconferencing program wherein the icons represent the functionality, a wireless transceiver establishes a wireless channel between the keyboard and the video teleconferencing program enabling a user to interact with the video teleconferencing program by pressing function keys on the keyboard.

In yet another embodiment, a method for interacting with a video teleconferencing program from a short distance is described. The method includes the steps of providing a small keyboard, the keyboard having a plurality of function keys with icons printed thereon, the function keys are configured to provide functionality of the video teleconferencing programs, pairing the keyboard and a video teleconferencing program using a Bluetooth channel, activating (i.e., actuating) at least one function key, and displaying the result of the function key on the video teleconferencing program.

In yet another embodiment, the method includes the step of muting and unmuting a microphone, turning on and off a camera, sending an emoji, and raising a hand icon.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the video conferencing keyboard device of the present invention in accordance with the disclosed architecture;

FIG. 2 illustrates a functional block diagram showing the internal components of the video conferencing keyboard device in accordance with the disclosed architecture;

FIG. 3 illustrates a schematic view of connection of the keyboard device with a video conferencing application in accordance with the disclosed architecture;

FIG. 4 illustrates a perspective view showing a user walking on a treadmill while using the video conferencing keyboard for participating in a video conference in accordance with the disclosed architecture;

FIG. 5 illustrates a perspective view of a user using the video conferencing keyboard secured in a wristband strap in accordance with the disclosed architecture;

FIG. 6 illustrates a perspective view of an exemplary user interface of a software application configured to provide functionality of the video teleconferencing program keyboard in accordance with the disclosed architecture; and

FIG. 7 illustrates a flow diagram depicting exemplary steps of using the video conferencing keyboard in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a system that enables users to move around and exercise and participate in their video teleconference meetings. There is also a long felt need in the art for a portable device that can be carried by a user while participating in teleconference meetings enabling the person to easily move around. Additionally, there is a long felt need in the art for a small keyboard-like handheld device that has function keys to interact with video teleconferencing programs from a distance. Moreover, there is a long felt need in the art for a system that prevents individuals from being stuck in their chairs for long hours while participating in virtual meetings. Further, there is a long felt need in the art for a system that can come in the form of a small keyboard, a software application, and more, enabling individuals to participate in video teleconferencing meetings while moving around. Furthermore, there is a long felt need in the art for a portable device that can help a user interact with a video conferencing application from a distance. Finally, there is a long felt need in the art for a handheld keyboard or a smartphone application that enables users to move around and exercise and participate in their teleconference meetings and prevents the users from being stuck in their chairs for multiple hours per day.

The present invention, in one exemplary embodiment, is a small keyboard that displays different function keys with icons designed for interacting with video teleconferencing programs from a distance. The keyboard is secured in an integrated wristband, which is configured to be worn around an arm by a user, the wristband having a transparent touch-sensitive pouch for securing the keyboard, the function keys are configured to emulate functions on a video teleconferencing program wherein the icons represent the functionality, a wireless transceiver establishes a wireless channel between the keyboard and the video teleconferencing program, enabling a user to interact with the video teleconferencing program by pressing function keys on the keyboard.

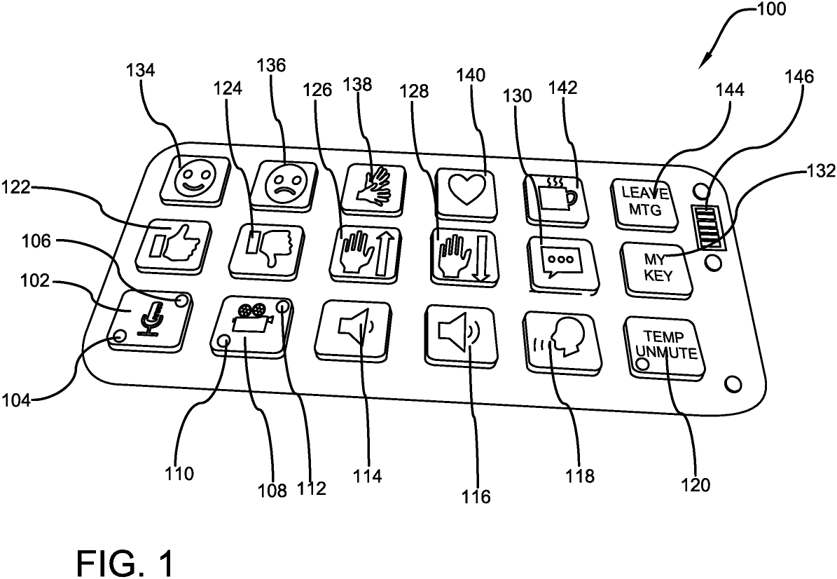

Referring initially to the drawings, FIG. 1 illustrates a perspective view of one potential embodiment of the video conferencing keyboard device of the present invention in accordance with the disclosed architecture. The video conferencing keyboard or keypad device 100 of the present invention is portable, lightweight, and has a plurality of function keys designed to interact with a plurality of video teleconferencing programs from a distance. More specifically, the keyboard or keypad 100 does not require a person to physically interact with a computer in which a video teleconferencing program is running and as a result, a person carrying the keyboard or keypad 100 can move around, do exercise, stretch and more while participating in their teleconference meetings without ignoring other bosses, employees, and the like.

The keyboard or keypad device 100 is a physical device that can be easily carried by a user and kept in a pocket as well. Each function key has an icon thereon for identifying the key and is configured to perform a specific function to control and participate in a video conferencing system or application. A microphone key 102 is used for temporarily activating and deactivating the microphone used for the video teleconferencing program. A green LED 104 is actuated on the key 102 when the microphone is activated (i.e., ON) and a red LED 106 is actuated on the key 102 when the microphone is deactivated. A camera key 108 is used for temporarily activating and deactivating the camera used for the conferencing program. A green LED 110 positioned on the key 108 indicates that the camera is activated (i.e., ON) and a red LED 112 on the key 108 when actuated indicates that the camera is deactivated (i.e., OFF).

A volume down button 114 is used for decreasing the volume of audio coming from speakers while using the video conferencing application. A volume up button 116 is used for increasing the volume of audio coming from the speakers. A speaker or talk key 118 is used by a user when the user wants to talk and speak in a conference. A separate temporary unmute key 120 is provided for activating the microphone used in the video teleconferencing program.

As during a conference, participants desire to send one or more reactions in the form of symbols and emojis, therefore, the video conferencing keyboard or keypad 100 provides a plurality of reaction keys to send symbols. A ‘Like’ or ‘Thumbs Up’ reaction key 122 is used for letting other participants know about your agreement. A ‘Thumbs Down’ reaction key 124 is used for letting other participants know about your disagreement. A ‘Raise Hand’ reaction key 126 is used for letting the host and other participants know that a user wants to speak and interact in the conference. The ‘Hand down’ reaction key 128 is used for lowering down the raised hand of the user. It should be noted that the reactions are displayed on the video teleconferencing program when a corresponding key is pressed by a user, thereby obviating the requirement of a user to sit down on computer.

A chat key 130 enables a user to chat or send a message by Natural Language Processing (NLP). The chat key 130 also opens a message bar of the video conferencing application. “My key” button 132 enables a user to provide the meeting key or access ID for starting and/or attending a video conference. In one embodiment, the keyboard or keypad 100 is paired with a specific video conferencing application and enables the user to automatically login into the application. A pair of emojis keys 134, 136 are used for sending an emoji reaction by a user. Similarly, other emoji keys include a ‘clapping’ key 138 for sending a clapping reaction and a heart key 140 for sending a heart reaction on a video conference.

A time break key 142 is used for indicating that a user is not present in the conference and can be used by a user when the user is unavailable. ‘Leave MTG’ key 144 can be used for instantly leaving a conference or meeting without actually using the conferencing application on a computer. A digital battery indicator 146 is used for indicating the battery level of the video conferencing keyboard or keypad 100 enabling a user to know about the battery status and requirement of charging of the battery of the keyboard or keypad 100.

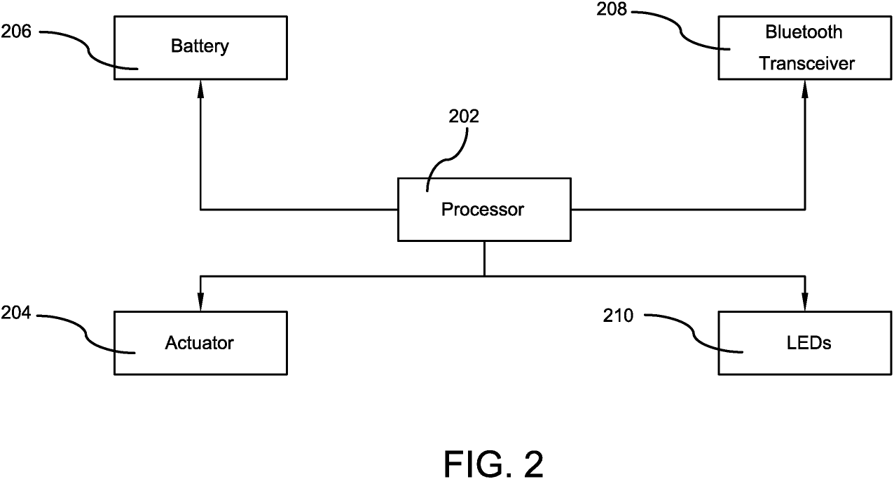

FIG. 2 illustrates a functional block diagram showing the internal components of the video conferencing keyboard or keypad device 100 in accordance with the disclosed architecture. The keyboard or keypad 100 has a processor 202 that can be implemented as a combination of software and hardware such as microprocessor, microcontroller, or the like. The processor 202 interprets which key disposed on the keyboard or keypad 100 is actuated and accordingly invokes the corresponding operation of the key. A central actuator 204 is used for actuating the functional keys disposed on the keyboard or keypad device 100 and when any of the keys are pressed or actuated, then, a signal is sent to the processor 202 for interpretation and invoking an operation. It should be noted that in some embodiments, the keys may be digital or soft keys and may not require an actuator for actuation.

An internal rechargeable Li-Ion battery 206 is used for providing electric power to the components of the keyboard or keypad 100. Further, the Li-Ion battery 206 is configured to be rechargeable using a USB-C rechargeable port disposed in the keyboard or keypad 100. In alternative embodiments, the keyboard or keypad 100 may use AA or AAA alkaline batteries. A Bluetooth transceiver 208 is used for sending wireless communication signals when one or more keys are actuated on the keyboard or keypad 100. The transceiver 208 is configured to establish a secure Bluetooth channel with a system in which a video conferencing application is running. The transceiver 208 is also configured to directly pair the keyboard or keypad 100 with the video conferencing application enabling easy transmission of signals from the keyboard or keypad 100.

The keyboard or keypad 100 has a plurality of LEDs 210 as illustrated in FIG. 1 for providing a visual indication to a user about functionality and operation of keys. Further, LEDs 210 can be of multiple colors as per user preferences and running power provided by the battery 206. All the components are embedded inside the keyboard or keypad 100 and sealed from water.

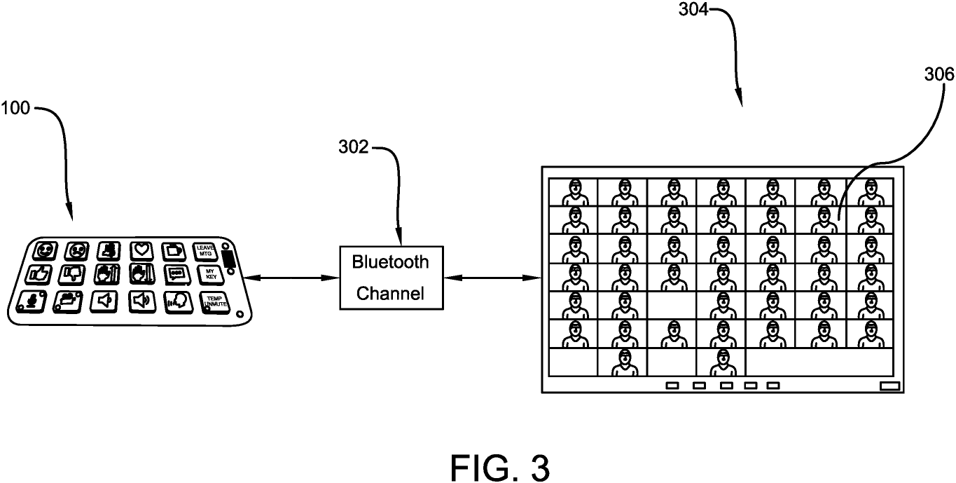

FIG. 3 illustrates a schematic view of connection of the keyboard device with a video conferencing application in accordance with the disclosed architecture. The keyboard or keypad 100 is configured to pair with a video conferencing application 306 running on a computing device 304 such as a computer, laptop computer, desktop computer, smart tv and more using Bluetooth channel 302. The Bluetooth channel 302 is established between the wireless transceiver of the keyboard or keypad 100 and of the computing device 304.

A wireless signal including an instruction corresponding to an actuated key on the keyboard is transmitted to the video conferencing application 306 that is displayed on the interface of the video conferencing application 306 and is also visible to other participants in the conference. It should be noted that the keyboard or keypad 100 is configured to have all the functionalities and controls that enable a user to actively participate in a video meeting while not requiring participants to be stuck at their desks.

The Bluetooth channel 302 enables a user to be away from the system 304 (i.e., a distance of at least 30 feet) thereby enabling the user to perform exercise, move around, or do any other physical activity. Accordingly, the keyboard or keypad 100 enables users to move around and exercise and participate in their teleconference meetings without ignoring bosses, employees, participants, and the like.

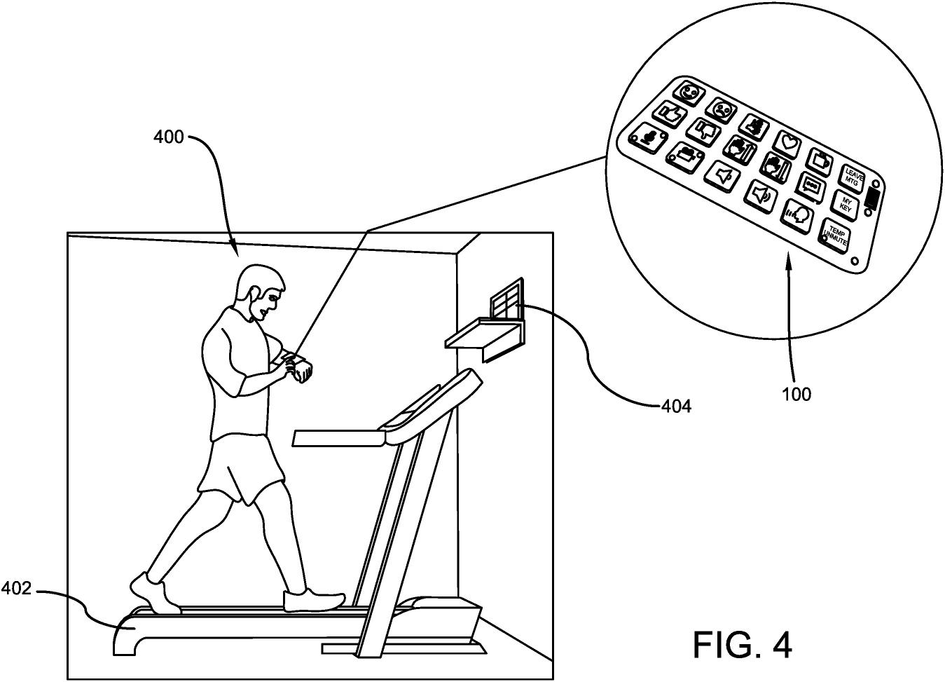

FIG. 4 illustrates a perspective view showing a user walking on a treadmill while using the video conferencing keyboard or keypad 100 for participating in a video conference in accordance with the disclosed architecture. As illustrated, the user 400 is walking on a treadmill 402 for doing exercise while controlling and participating in the video conference 306 running on the laptop 404 using the keyboard or keypad 100. The functional keys provided on the keyboard or keypad 100 are used by the user 400 as described in FIG. 1 for participating in the conference.

The keyboard or keypad 100 is configured to provide a mobile communication method for moving around and exercising and participating in their video teleconference meetings without ignoring other participants. Further, the user is not required to remain seated while interacting with their computer 404.

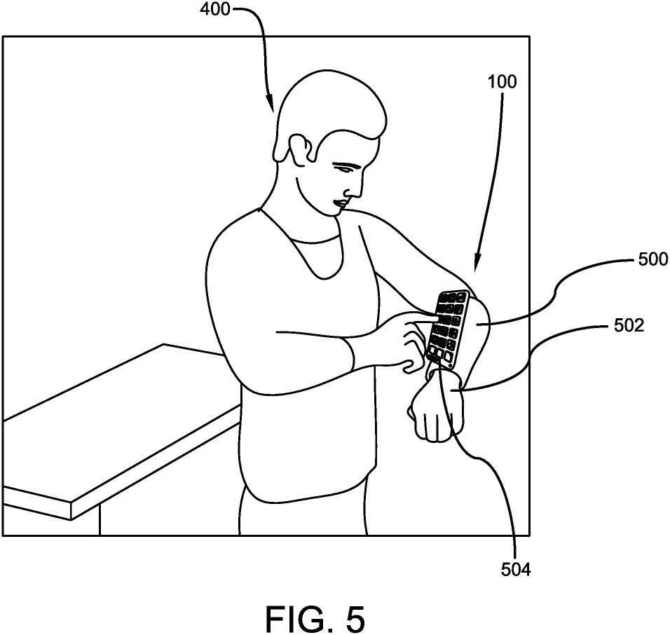

FIG. 5 illustrates a perspective view of a user using the video conferencing keyboard or keypad 100 secured in a wristband strap in accordance with the disclosed architecture. The present invention provides a wristband strap 500 that is designed to wrap around a user’s wrist in order to secure the keyboard or keypad 100 thereto. The wristband strap 500 enables the user 400 to securely use the keyboard or keypad 100.

The wristband strap 500 is wrapped around an arm 502 of the user 400 and may have hook and loop fasteners or snap buttons for securing around the arm 502. Further, the strap 500 has a touch-sensitive transparent pouch 504 for operating the keyboard or keypad 100 while the keyboard or keypad 100 is secured in the strap 500. The wristband strap 500 enables a user to easily participate in a meeting while doing physical work away from his desk.

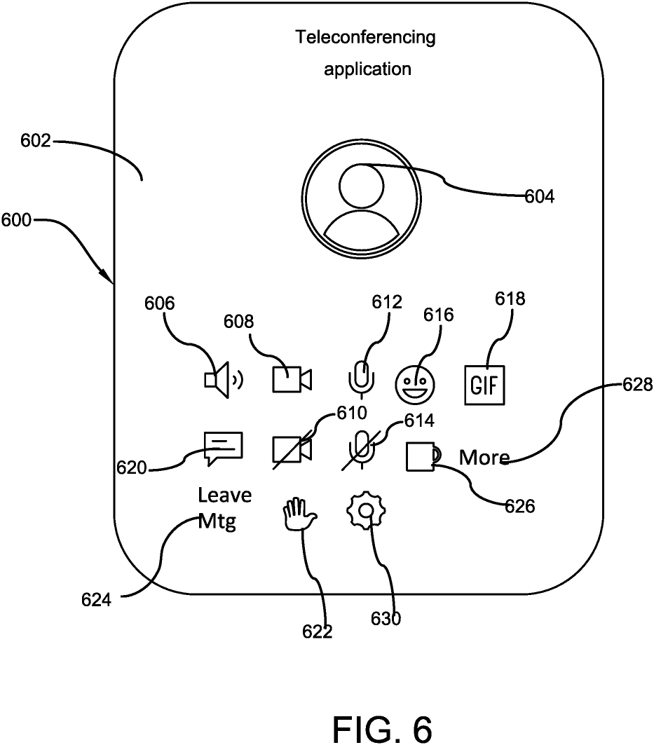

FIG. 6 illustrates a perspective view of an exemplary user interface of a software application configured to provide functionality of the video teleconferencing program keyboard or keypad 100 in accordance with the disclosed architecture. The present invention is configured to provide a smartphone application 600 configured to be installed in any smartphone and provides the controls and functional soft keys for participating in a video conference while using the video conferencing keyboard or keypad 100.

More specifically, the user interface 602 displays a profile picture 604 of a user using the software application 600. The interface 602 is designed to provide a plurality of options/icons for participating in a video conference meeting. A speaker icon 606 enables changes in volume, video buttons 608, 610 enable a user to turn on and off the camera, respectively. Microphone controls 612, 614 enable users to turn on and off the microphone used in the meeting. Emoji icon 616 enables users to view a grid of emojis for selection to post in the video meeting, a GIF icon 618 is used for inserting one or more GIFs into the meeting.

A user can chat in the meeting using the chat icon 620, a hand raise button 622 is used for raising a hand up or down, a ‘leave meeting’ button 624 is used by a user for instantly leaving the meeting. A ‘break’ icon 626 is used for indicating that the user is on break and a ‘more’ button 628 is used for displaying more options provided by the software application 600. A ‘setting’ button 630 is used for changing settings such as display settings, connection settings, and more of the user interface 602 and of participation in a meeting.

It should be noted that in some embodiments, the software application 600 can be provided by a video conferencing service provider such as Zoom, Microsoft Teams and more. Alternatively, the software application can be provided by a 3^{rd} party service provider and has the capability of integrating and compatibility with a plurality of video conferencing service providers.

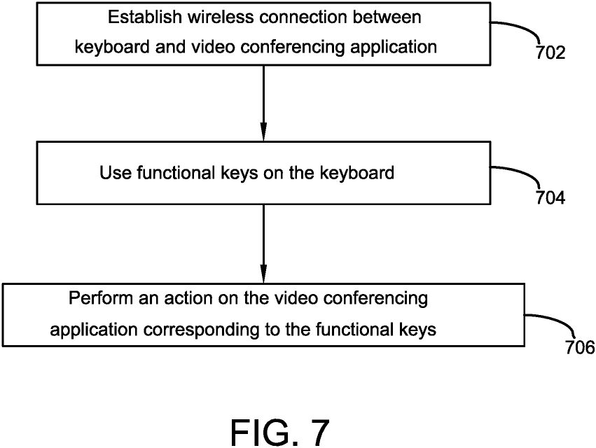

FIG. 7 illustrates a flow diagram depicting exemplary steps of using the video conferencing keyboard in accordance with the disclosed architecture. As illustrated, initially, the keyboard is paired with a video conferencing application using Bluetooth channel (Step 702). Then, one or more functional keys provided on the keyboard are used by a user as per preference (Step 704) for participating in a meeting from a distance. Finally, actions corresponding to the functional keys used by the user are performed in the video conferencing application in real time (Step 706).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “video conferencing keyboard”, “keyboard”, “keyboard device”, and “video teleconferencing keyboard” are interchangeable and refer to the video teleconferencing keyboard or keypad device 100 of the present invention.

Notwithstanding the forgoing, the video teleconferencing keyboard or keypad device 100 of the present invention can be of any suitable size and configuration as is known in the art without affecting the overall concept of the invention, provided that it accomplishes the above stated objectives. One of ordinary skill in the art will appreciate that the video teleconferencing keyboard or keypad device 100 as shown in the FIGS. are for illustrative purposes only, and that many other sizes and shapes of the video teleconferencing keyboard or keypad device 100 are well within the scope of the present disclosure. Although the dimensions of the video teleconferencing keyboard or keypad device 100 are important design parameters for user convenience, the video teleconferencing keyboard or keypad device 100 be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wearable keypad device for a user to participate in a video conferencing system, the keypad device comprising:
a microphone key for actuating a microphone having a green LED for indicating an ON position and a red LED for indicating an OFF position;
a camera key for actuating a camera having a green LED for indicating an ON position and a red LED for indicating an OFF position;
a speaker having a volume down button for decreasing a volume of an audio and a volume up button for increasing a volume of said audio;
a talk key for speaking in a conference;
an unmute key for actuating said microphone in said conference;
a reaction key for sending a reaction to said conference;
wherein said conference is a video conference;
a wrist strap for mounting said keypad to a wrist of said user; and
a Bluetooth channel for connecting and pairing said keypad device to a computer video conferencing application.

2. The keypad device of claim 1, wherein said reaction key is selected from a group consisting of a ‘Like’, a ‘Thumbs Up’, a Thumbs Down’, a ‘Raise Hand’, and a ‘Hands Down’.

3. The keypad device of claim 2, wherein said reaction key is selected from a group consisting of a ‘happy’, an ‘unhappy’, an ‘applause’, and a ‘love’.

4. The keypad device of claim 3 further comprising a ‘time break key’ for indicating said user is on a break from said videoconference.

5. The keypad device of claim 4 further comprising a ‘leave meeting key’ for indicating said user has left said video conference.

6. The keypad device of claim 5 further comprising a ‘my key’ for said user to provide an access ID for starting said video conference.

7. The keypad device of claim 5 further comprising a ‘my key’ for said user to provide an access ID for attending said video conference.

8. The keypad device of claim 5 further comprising a digital battery indicator for indicating a battery level status of said keypad device.

9. A wearable keypad device for a user to participate in a video conferencing system, the keypad device comprising:
a microphone key for actuating a microphone having a green LED for indicating an ON position and a red LED for indicating an OFF position;
a camera key for actuating a camera having a green LED for indicating an ON position and a red LED for indicating an OFF position;
a speaker having a volume down button for decreasing a volume of an audio and a volume up button for increasing a volume of said audio;
a talk key for speaking in a conference;
an unmute key for actuating said microphone in said conference;
wherein said conference is a video conference;
a wrist strap for mounting said keypad to a wrist of said user;
a processor having a microcontroller for interpreting an actuated key;
a Bluetooth channel for connecting and pairing said keypad device to a computer video conferencing application; and
wherein said microcontroller sending a signal from said keypad device to said computer video conferencing application for operation of said actuated key.

10. The keypad device of claim 9 further comprising a reaction key for sending a reaction to said conference, wherein said reaction key is selected from a group consisting of a ‘Like’, a ‘Thumbs Up’, a Thumbs Down’, a ‘Raise Hand’, and a ‘Hands Down’.

11. The keypad device of claim 10, wherein said reaction key is selected from a group consisting of a ‘happy’, an ‘unhappy’, an ‘applause’, and a ‘love’.

12. The keypad device of claim 11 further comprising a ‘time break key’ for indicating said user is on a break from said video conference.

13. The keypad device of claim 12 further comprising a ‘leave meeting key’ for indicating said user has left said video conference.

14. The keypad device of claim 13 further comprising a ‘my key’ for said user to provide an access ID for starting said video conference.

15. The keypad device of claim 13 further comprising a ‘my key’ for said user to provide an access ID for attending said video conference.

16. The keypad device of claim 13 further comprising a digital battery indicator for indicating a battery level status of said keypad device.

17. A wearable keypad device for a user to participate in a conferencing system, the keypad device comprising:
a microphone key for actuating a microphone having a green LED for indicating an ON position and a red LED for indicating an OFF position;
a camera key for actuating a camera having a green LED for indicating an ON position and a red LED for indicating an OFF position;
a speaker having a volume down button for decreasing a volume of an audio and a volume up button for increasing a volume of said audio;
a talk key for speaking in a conference;
a wrist strap for mounting said keypad to a wrist of said user;
a processor having a microcontroller for interpreting an actuated key;
a Bluetooth channel for connecting and pairing said keypad device to said conferencing application;
wherein said microcontroller sending a signal from said keypad device to said computer conferencing application for operation of said actuated key; and
wherein said computer conferencing application is selected from a group consisting of a computer, a laptop computer, a desktop computer, and a smart TV.

18. The keypad device of claim 17, wherein said computer conferencing application is a video computer conferencing application.

19. The keypad device of claim 18 further comprising a reaction key for sending a reaction to said conference, wherein said reaction key is selected from a group consisting of a ‘Like’, a ‘Thumbs Up’, a ‘Thumbs Down’, a ‘Raise Hand’, a ‘Hands Down’, a ‘happy’, an ‘unhappy’, an ‘applause’, and a ‘love’.

20. The keypad device of claim 19 further comprising a ‘time break key’ for indicating said user is on a break from said video conference.
